(19) United States
(12) Patent Application Publication
(10) Pub. No.: US 2026/0074949 A1
(43) Pub. Date: Mar. 12, 2026

(54) APPARATUS AND METHOD FOR DIAGNOSTIC COMMUNICATION IN VEHICLE AND VEHICLE INCLUDING THE SAME

(71) Applicants: HYUNDAI MOTOR COMPANY, Seoul (KR); KIA CORPORATION, Seoul (KR)

(72) Inventor: Jae Hun LEE, Hwaseong-si (KR)

(73) Assignees: HYUNDAI MOTOR COMPANY, Seoul (KR); KIA CORPORATION, Seoul (KR)

(21) Appl. No.: 19/056,321

(22) Filed: Feb. 18, 2025

(30) Foreign Application Priority Data
Sep. 12, 2024 (KR) 10-2024-0124559

(51) Int. Cl. H04L 41/0654; B60R 16/023; G07C 5/00; H04L 12/66; H04L 43/12; H04L 67/12

(52) U.S. Cl. CPC H04L 41/0654; B60R 16/023; G07C 5/008; H04L 12/66; H04L 43/12; H04L 67/12

(57) ABSTRACT

A method for diagnostic communication in a vehicle involves connecting a communication node to another communication node according to a predetermined connection sequence. The method includes monitoring the communication connection status of one node to determine if it meets a predefined error condition and selectively performing a recovery procedure if the error condition is satisfied. This approach facilitates error recognition and recovery, reducing communication failures, delays, and unnecessary resource usage in vehicle networks.

### CROSS-REFERENCE TO RELATED APPLICATION(S)

This application claims the benefit of priority to Korean Patent Application No. 10-2024-0124559, filed on Sep. 12, 2024, in the Korean Intellectual Property Office, the disclosure of which is incorporated herein by reference in its entirety.

### BACKGROUND

### 1. Field

The present disclosure relates to a method and apparatus for diagnostic communication in a vehicle and a vehicle including the same.

### 2. Description of Related Art

As vehicle technology advances, vehicles may be provided with various electronic control modules, and such electronic control modules may control various devices or systems mounted in the vehicle. Examples of electronic control modules may include an Electric Control Unit (ECU), a Transmission Control Unit (TCU), an Airbag Control Unit (ACU), an Antilock Braking System (ABS), a measuring instrument and driver information module, or similar components.

Electronic control modules may be connected via a vehicle network, and may monitor various control inputs and operating parameters transmitted via the vehicle network and control devices or systems accordingly. For example, an engine control module (ECM) may receive accelerator pedal deflation as an input to control the engine's ignition and a fuel system. In addition, the engine control module (ECM) may monitor engine speed, torque, and other operating parameters to optimize engine performance. Some controls or operating parameters monitored by one module may also be requested by one or more other modules. For example, the engine speed monitored by the engine control module may be requested by a transmission control module, a brake release module, and an instrument and driver information module. Additionally, wheel speed monitored by an anti-lock brake system module may be used by the engine control module and the transmission control module for the purpose of traction control.

Since the electronic control module is disposed within a vehicle, a vehicle diagnostic apparatus (e.g., an On Board Diagnostics device) may diagnose an electronic control module by communicating with the electronic control module according to a diagnostic communication protocol (e.g., a Diagnostics over Internet Protocol (DoIP)) via a vehicle network (e.g., Ethernet).

### SUMMARY

From an external viewpoint of a vehicle, it may be difficult to recognize or recover from a communication connection error between a plurality of communication nodes in the vehicle. In a method and apparatus for diagnostic communication in a vehicle, and a vehicle including the same according to an embodiment of the present disclosure, by pre-defining a communication connection error recognition/recovery procedure between a plurality of communication nodes in the vehicle, before diagnosis, the impact of the occurrence of communication connection errors (e.g., communication failure/delay time, unnecessary resources of a vehicle network, confusion in diagnostic schedules) may be effectively reduced.

According to an aspect of the present disclosure, a method for diagnostic communication in a vehicle may include: an operation in which one of a plurality of communication nodes in a vehicle is connected to another of the plurality of communication nodes for communication therewith according to a predetermined connection sequence; an operation in which one of the plurality of communication nodes monitors whether a communication connection status for another of the plurality of communication nodes satisfies a predetermined communication connection error condition; and an operation in which one of the plurality of communication nodes selectively performs a predetermined communication connection recovery procedure depending on whether the communication connection status satisfies the predetermined communication connection error condition.

According to an aspect of the present disclosure, an apparatus for diagnostic communication in a vehicle may include: an edge communication node configured to receive a message from outside the vehicle and to protocol-convert or route the received message; and a control communication node configured to receive the message protocol-converted or routed by the edge communication node. The edge communication node may be configured to connect to the control communication node for communication according to a predetermined connection sequence, monitor whether the communication connection status of the control communication node satisfies a predetermined error condition, and selectively perform a predetermined recovery procedure based on whether the communication connection status satisfies the error condition.

According to an aspect of the present disclosure, a vehicle may include a computing device having a processor and a storage medium on which one or more programs configured to be executed by the processor is recorded, wherein the one or more programs include commands for executing the method for diagnostic communication in a vehicle.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a diagram illustrating a specific embodiment of a method and apparatus for diagnostic communication in a vehicle and a vehicle according to an embodiment of the present disclosure;

FIGS. 2A and 2B are block diagrams illustrating a plurality of nodes of a method and apparatus for diagnostic communication in a vehicle according to an embodiment of the present disclosure;

FIGS. 3A and 3B are diagrams illustrating a predetermined communication connection error condition of a method and apparatus for diagnostic communication in a vehicle according to an embodiment of the present disclosure;

FIGS. 4A to 4C are diagrams illustrating a predetermined communication connection recovery procedure of a method and apparatus for diagnostic communication in a vehicle according to an embodiment of the present disclosure;

FIG. 5 is a diagram illustrating periodically transmitting a monitoring message by a method and apparatus for diagnostic communication in a vehicle according to an embodiment of the present disclosure;

FIG. 6 is a flowchart illustrating a method for diagnostic communication in a vehicle according to an embodiment of the present disclosure; and

FIG. 7 is a flowchart more specifically illustrating a method for diagnostic communication in a vehicle according to an embodiment of the present disclosure.

### DETAILED DESCRIPTION

Since the present disclosure may undergo various changes and may have various exemplary embodiments of the present disclosure, specific embodiments may be illustrated in the drawings and described in detail. However, this is not intended to limit the present disclosure to specific embodiments, it should be understood to include all modifications, equivalents, and substitutes included in the spirit and technical scope of the present disclosure.

Terms such as first, second, and the like may be used to describe various elements, but the elements should not be limited by the terms. The above terms may be used only for distinguishing one component from another. For example, without departing from the scope of the present disclosure, a first component may be referred to as a second component, and similarly, a second component may also be referred to as a first component. The term “and/or” may include a combination of a plurality of related listed items or any of the plurality of related listed items.

The terms used in the present application may be only used to describe specific embodiments, and are not intended to limit the present disclosure. The singular expression may include the plural expression, unless the context clearly dictates otherwise. In the present application, it should be understood that terms such as “include,” “comprise,” or “have” are intended to designate that features, numerals, steps, operations, components, parts, or combination thereof described in the specification exists, but one or more other features this does not preclude the existence or addition of numbers, steps, operations, components, parts, or combinations thereof.

Unless otherwise defined, all terms used herein, including technical or scientific terms, have the same meaning as that which can commonly understood by one of ordinary skill in the art to which the present disclosure belongs. Terms such as those defined in a commonly used dictionary should be interpreted as having a meaning consistent with the meaning in the context of the related art, and should not be interpreted in an ideal or excessively formal manner unless explicitly defined in the present application.

In the present specification, a vehicle (including an electric vehicle) refers to a variety of vehicles for moving an object to be transported, such as people, animals, or goods, from a starting point to a destination. These vehicles are not limited to vehicles that run on roads or tracks.

Hereinafter, preferred embodiments of the present disclosure will be described in greater detail with reference to the accompanying drawings.

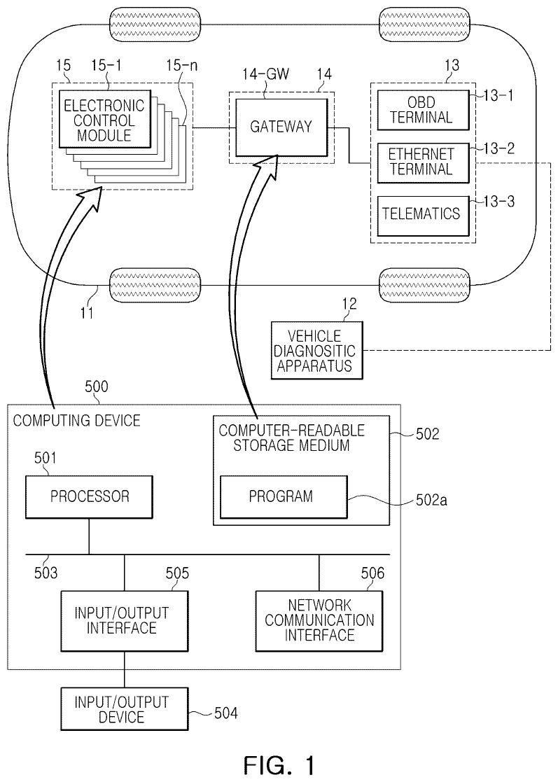

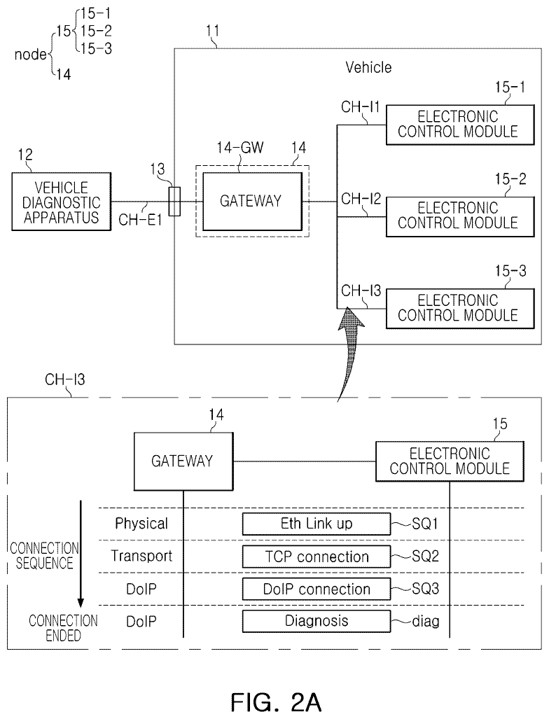

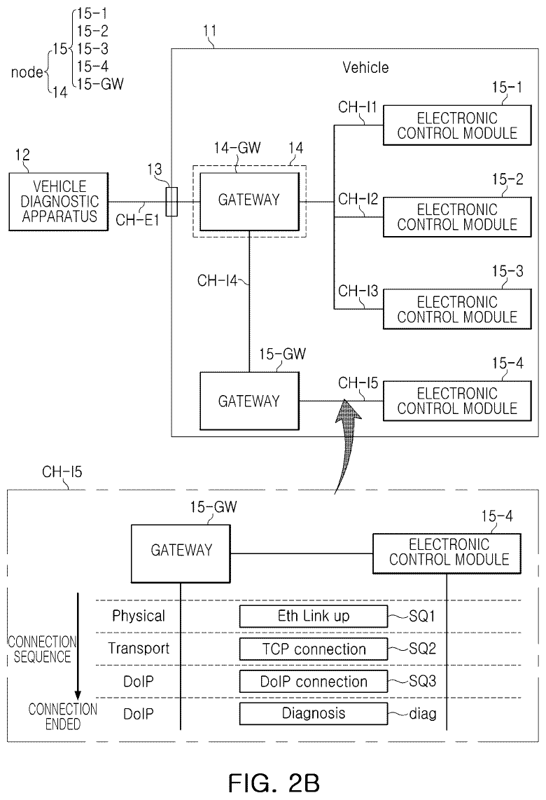

FIG. 1 is a diagram illustrating a specific embodiment of a method and apparatus for diagnostic communication in a vehicle according to an embodiment of the present disclosure. Referring to FIGS. 1, 2A, and 2B, a vehicle 11 may include a plurality of electronic control modules 15-1 to 15-n for collecting, providing, and transmitting information required for driving, information required for driving, or information for enhancing driving safety to a user, driver, or passenger.

The plurality of electronic control modules 15-1 to 15-n may be connected to each other through a vehicle network and exchange data. The plurality of electronic control modules 15-1 to 15-n may include information collection devices such as sensors and cameras, as well as information processing devices that can perform calculations based on collected information according to preset programs and functions to create and process new information.

For example, each of the plurality of electronic control modules 15-1 to 15-n may be implemented as an electronic control unit (ECU) controlling various devices included in the vehicle. The ECU may be implemented as an ECU that controls an infotainment device (e.g., a display device, a navigation device, an around view monitoring device), or the like, and may also be implemented as an engine control unit, a transmission control unit, an engine management system electronic control unit (EMS ECU), a transmission management system electronic control unit (TMS ECU), an airbag control module (ACU), an anti-locking brake system electronic control unit (ABS ECU), a measuring instrumentation and driver information module.

The plurality of electronic control modules (15-1 to 15-n) may be interconnected through a hierarchical network structure via an edge gateway 14-GW. The edge gateway 14-GW may include a computer or software which enables communication between networks using different communication networks and protocols in a vehicle network, may be a network point acting an entrance to different networks, and may also act as a passage between different types of networks.

The vehicle 11 may include an edge gateway 14-GW, and the number of edge gateways 14-GW included in the vehicle 11 may be determined corresponding to the number and connection type of the plurality of electronic control modules 15-1 to 15-n mounted in the vehicle.

A vehicle diagnostic apparatus 12 for diagnosing the plurality of electronic control modules (15-1 to 15-n) mounted in a vehicle 11 may be connected or linked to the vehicle 11. The vehicle diagnostic apparatus 12 may diagnose the plurality of electronic control modules (15-1 to 15-n) connected through a vehicle network of a plurality of different communication methods. The vehicle diagnostic apparatus 12 may be in the form of a terminal that is physically separated from the vehicle but can be connected through terminals mounted in the vehicle. In addition, according to an embodiment, the vehicle diagnostic apparatus 12 may be in the form of a network server that can check the plurality of electronic control modules (15-1 to 15-n) mounted in the vehicle and collect data through a wired/wireless communication network.

Meanwhile, there may be an input/output means 13 for transmitting data to perform a diagnostic process and collect the results between the vehicle diagnostic apparatus 12 and the edge gateway 14-GW. For example, the input/output means 13 may include an On-Board Diagnostics (OBD) terminal 13-1 disposed in the vehicle. Here, On-Board Diagnostics (OBD) refers to a diagnostic standard for checking and controlling an electrical/electronic operation status of a vehicle 11. Initially, OBD was used to increase the maintenance efficiency of electronic components, such as engines, but in addition to this purpose, OBD also serves as an interface as a trip computer showing various vehicle information to a driver.

As the number of electronic control modules (15-1 to 15-n) mounted in the vehicle 11 increases and an amount of data transmitted and received by the electronic control modules (15-1 to 15-n) increases, an Ethernet communication may be applied to a vehicle network, and depending on the design, a Controller Area Network (CAN) communication may be further applied. For example, a maximum transmission bandwidth of CAN communication, which is a measurement control communication network, may be 1 Mbps. When the number of electronic control modules (15-1 to 15-n) in the vehicle 11 increases at this speed, and data traffic increases rapidly due to real-time video transmission (e.g., Top view monitoring), there may be limitations in configuring a vehicle network using only a CAN communication. Meanwhile, a data transmission rate of CAN-FD may be up to 2 Mbit/s in a multi-drop network and be up to 5 Mbit/s in a point-to-point communication, and in the case of Ethernet, a speed of 1 Gbps is also proposed. Therefore, in the process of checking and controlling an electrical/electronic operation status of the vehicle 11, a vehicle diagnostic apparatus 12 may be connected through an Ethernet terminal 13-2.

Depending on the design, a protocol of the vehicle network may be based on Ethernet and CAN, as well as CAN with Flexible Data-Rate (CAN-FD), Local Interconnect Network (LIN) communication, Media Oriented Systems Transport (MOST) communication, or the like, or may be replaced by, CAN-FD, LIN communication, MOST communication, or the like, but an embodiment thereof is not limited thereto.

Depending on the design, the input/output means 13 may use a telematics apparatus 13-3 mounted in the vehicle 11. The telematics apparatus 13-3 is an example of an apparatus that can provide a comprehensive multimedia service for a vehicle using location information and a wireless communication network, which may provide safe driving, emergency rescue, traffic guidance services, or the like, to drivers, and may provide infotainment services such as Internet, movies, games, and multimedia to passengers. In addition, the telematics device 13-3 may transmit a diagnostic message for checking and a plurality of electronic control modules (15-1 to 15-n) and collecting data therefrom by communicating with a network server for diagnosing operations of devices in the vehicle, and transmit data transmitted from the plurality of electronic control modules 15-1 to 15-n mounted in the vehicle to the network server.

A diagnostic message that can be transmitted through the edge gateway 14-GW may be transmitted through a User Datagram Protocol (UDP) and/or a Transmission Control Protocol (TCP) among Transport Layer Protocols. For example, for vehicle diagnosis (Diagnostic Access), a diagnostic protocol based on IEEE802.3 and IPv4/IPv6 (Diagnostics over IP, DoIP) may be used, and a diagnostic protocol based on CAN (Diagnostics over CAN, DoCAN) may be used.

A system for vehicle diagnosis may include at least one of a message generator for generating a diagnostic message for diagnosing a plurality of electronic control modules 15-1 to 15-n mounted on a vehicle and a message receiver for recognizing the diagnostic message. The message generator and/or the message receiver may be included in each of a plurality of electronic control modules 15-1 to 15-n, a vehicle diagnostic apparatus 12, and an edge gateway 14-GW.

The plurality of electronic control modules (15-1 to 15-n) may communicate with devices connected to other vehicle networks through an edge gateway 14-GW, and the edge gateway 14-GW may perform a switching role for the plurality of vehicle networks. The edge gateway 14-GW may be an interface between the plurality of electronic control modules (15-1 to 15-n). For example, the edge gateway 14-GW transmitting messages and signals according to a diagnostic protocol (e.g., DoIP, DoCAN) for networking with the vehicle diagnostic apparatus 12 based on Ethernet/IP may provide scheduling and protocol conversion functions for communicating with the plurality of electronic control modules (15-1 to 15-n).

For example, a plurality of communication nodes forming a vehicle network may be connected in star topology, bus topology, ring topology, tree topology, mesh topology, or the like, but an embodiment thereof is not limited thereto. For example, communication nodes forming a vehicle network may be connected in a star topology, bus topology, ring topology, tree topology, mesh topology, or similar configurations; however, embodiments are not limited to these examples. Each communication node in the vehicle network may support a CAN protocol, a FlexRay protocol, a MOST protocol, a LIN protocol, an Ethernet protocol, or similar protocols; however, embodiments are not limited to these examples.

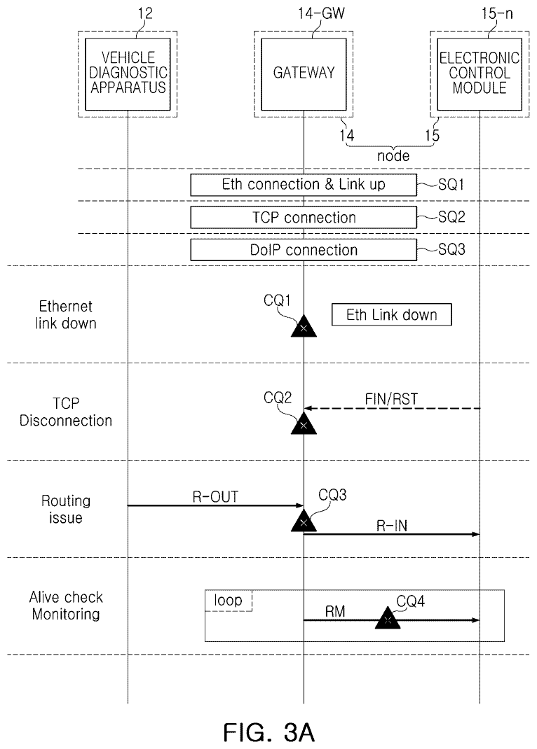

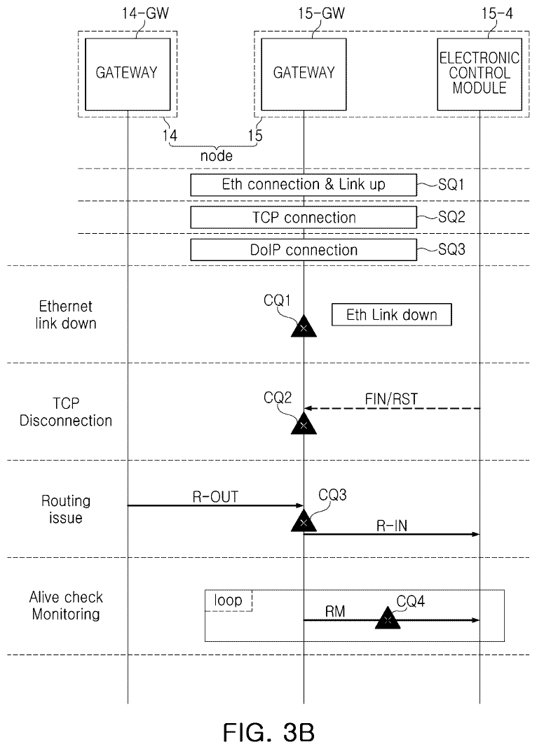

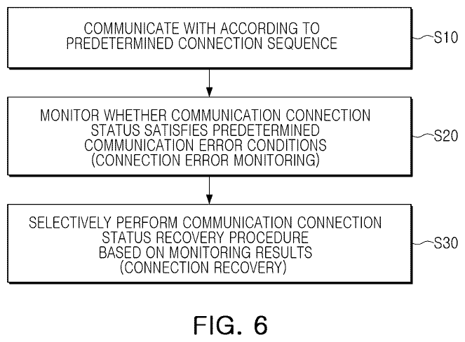

FIGS. 2A and 2B are block diagrams illustrating a plurality of nodes of a method and apparatus for diagnostic communication in a vehicle according to an embodiment of the present disclosure, FIGS. 3A and 3B are diagrams illustrating a predetermined communication connection error condition of a method and apparatus for diagnostic communication in a vehicle according to an embodiment of the present disclosure, and FIG. 6 is a flowchart illustrating a method for diagnostic communication in a vehicle according to an embodiment of the present disclosure.

Referring to FIGS. 2A and 3A, the plurality of communication nodes may include an edge communication node 14 and a control communication node 15, the edge communication node 14 may include an edge gateway 14-GW, and the control communication node 15 may include a plurality of electronic control modules 15-1, 15-2, 15-3, and 15-4. Referring to FIGS. 2B and 3B, the control communication node 15 may further include a control gateway 15-GW.

The apparatus for diagnostic communication in a vehicle according to an embodiment of the present disclosure may include an edge communication node 14 receiving a message from outside of a vehicle (e.g., a vehicle diagnostic apparatus 12) and protocol converting or routing the message, and a control communication node 15 receiving the message protocol converted or routed by the edge communication node 14. For example, the edge gateway 14-GW of the edge communication node 14 may perform protocol conversion between a first protocol (e.g., Ethernet, DoIP) and a second protocol (e.g., CAN, DoCAN) for messages transmitted and received between a vehicle diagnostic apparatus 12 and a control communication node 15, or perform simple routing without protocol conversion.

The edge communication node 14 may be configured to be connected to the outside of the vehicle (e.g., a vehicle diagnostic apparatus 12) for communication therewith via an external channel CH-E1, and the plurality of communication nodes may be configured to be connected to each other for communication therewith via a plurality of internal channels CH-I1, CH-I2, CH-I3, CH-I4, and CH-I5. For example, each of the external channel CH-E1 and the plurality of internal channels CH-I1, CH-I2, CH-I3, CH-I4, and CH-I5 may have a communication connection status in each of a plurality of layers of a communication model (e.g., OSI standard model, TCP (transfer control protocol)/IP (Internet protocol) model).

For example, according to the Open Systems Interconnection (OSI) standard model, the plurality of layers may be comprised of 1 to 7. Layer 1 of the communication node may support PHY functions, and may support a transmission speed of 100 megabits per second (Mbps). Layer 2 of the communication node may support IEEE 802.1Q protocol, IEEE 802.1p protocol, IEEE 802.3 protocol, AVB (audio video bridging) protocol (e.g., IEEE 802.1Qav protocol, IEEE 802.1Qat protocol), or the like. Layer 3 of the communication node may support IPv4 (internet protocol version 4), ARP (address resolution protocol), ICMPv4 (internet control message protocol version 4), IEEE 802.1AS, IEEE 1722, or the like. Layer 4 of the communication node may support TCP (transfer control protocol), UDP (user datagram protocol), IEEE 802.1AS, IEEE 1722, or the like. Layers 5 to 7 of the communication node may support diagnostics over internet protocol (DoIP), diagnostics over CAN (DoCAN), EthCC protocol, dynamic host configuration protocol (DHCP), SD protocol, network management (NM) protocol, IEEE 802.1AS, IEEE 1722, or the like.

From a perspective of the outside of the vehicle (e.g., the vehicle diagnostic apparatus 12), it may be more difficult to recognize/recover a communication connection error in the plurality of internal channels CH-I1, CH-I2, CH-I3, CH-I4, and CH-I5, as compared to recognize/recover a communication connection error in the external channel CH-E1. This is because the outside of the vehicle (e.g., the vehicle diagnostic apparatus 12) is not directly connected to the plurality of internal channels CH-I1, CH-I2, CH-I3, CH-I4, and CH-I5.

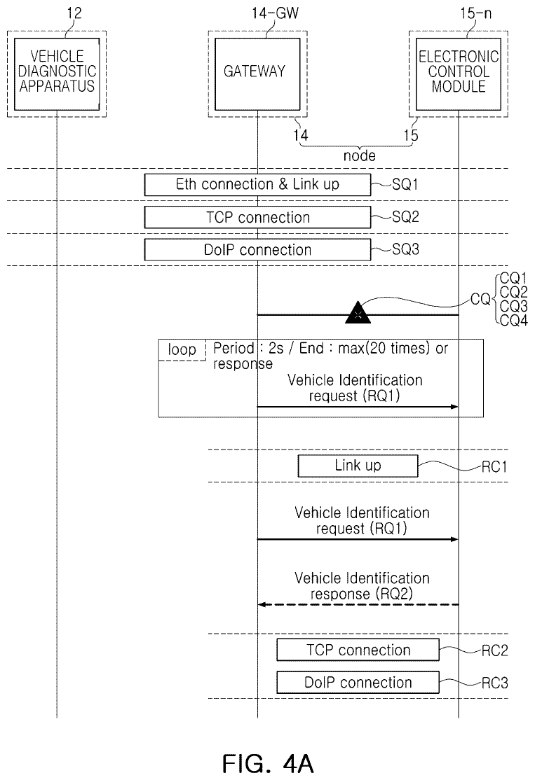

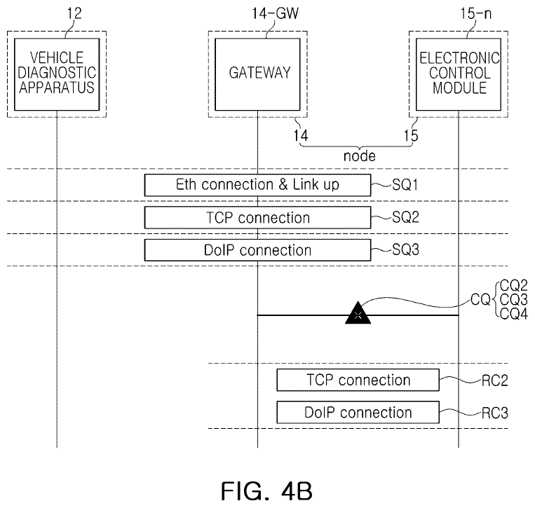

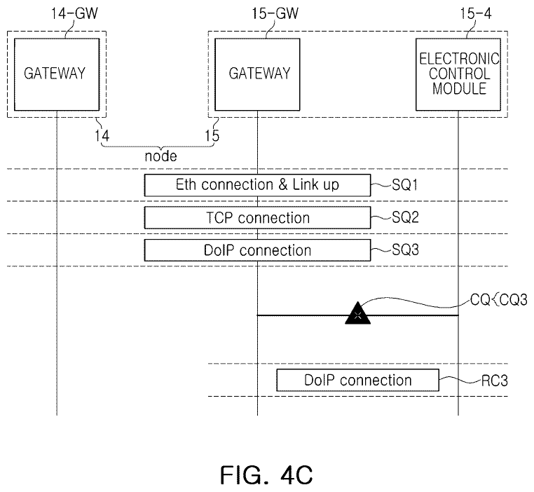

Referring to FIG. 2A, FIG. 3A, FIG. 4A, and FIG. 6, the method and apparatus for diagnostic communication in a vehicle according to an embodiment of the present disclosure may include an operation (S10 of FIG. 6) in which one of a plurality of communication nodes in a vehicle 11 (e.g., an edge communication node 14) is connected to another of the plurality of communication nodes for communication therewith according to predetermined connection sequences (SQ1, SQ2, and SQ3 of FIG. 2A); an operation (S20 of FIG. 6) in which one of a plurality of communication nodes (e.g., an edge communication node 14) monitors whether a communication connection status for another of the plurality of communication nodes (e.g., a control communication node 15) satisfies predetermined communication connection error conditions (CQ1, CQ2, CQ3, CQ4 of FIG. 3A); and an operation (S30 of FIG. 6); and an operation (S30 of FIG. 6) in which one of a plurality of communication nodes (e.g., an edge communication node 14) selectively performs predetermined communication connection recovery conditions (RQ1, RC1, RC2, and RC3 of FIG. 4A) depending on whether the communication connection status satisfies predetermined communication connection error conditions (CQ1, CQ2, CQ3, and CQ4 of FIG. 3A).

As described above, in the method and apparatus for diagnostic communication in a vehicle according to an embodiment of the present disclosure, by pre-defining a communication connection error recognition/recovery procedure between a plurality of internal channels (CH-I1, CH-I2, CH-I3, CH-I4, and CH-I5), before diagnosis, the impact of the occurrence communication connection errors (e.g., communication failure/delay time, unnecessary resources of a vehicle network, confusion in diagnostic schedules) may be effectively reduced.

Referring to FIG. 2B, FIG. 3B and FIG. 4C, the control gateway 15-GW may be configured to be connected to electronic control modules 15-1 to 15-n for communication therewith according to predetermined connection sequences (SQ1, SQ2, and SQ3 of FIG. 2B), monitor whether a communication connection status for the electronic control modules 15-1 to 15-n satisfies predetermined communication connection error conditions CQ1, CQ2, CQ3, and CQ4 of FIG. 3b, and selectively perform predetermined communication connection recovery procedures (RQ1, RC1, and RC2 of FIG. 4A, RC3 of FIG. 4C) depending on whether the communication connection status satisfies predetermined communication connection error conditions (CQ1, CQ2, CQ3, and CQ4 of FIG. 3B).

Predetermined connection sequences (SQ1, SQ2, and SQ3 of FIGS. 2A and 2B) may include at least one of an Ethernet connection (Eth connection & Link up) corresponding to a physical layer or a network access layer of a communication model (e.g., OSI standard model, TCP/IP model), a TCP (Transmission Control Protocol) connection corresponding to a transmission layer of the communication model (e.g., OSI standard model, TCP/IP model), and a DoIP (Diagnostic over Internet Protocol) connection corresponding to an application layer of the communication model (e.g., OSI standard model, TCP/IP model). For example, the predetermined connection sequences (SQ1, SQ2, and SQ3 of FIGS. 2A and 2B) may further include connection order information for sequentially performing an Ethernet connection (Eth connection & Link up), a TCP connection, and a DoIP connection.

For example, the Ethernet connection (Eth connection & Link up) may include connecting an Ethernet cable between a plurality of communication nodes, the TCP connection may include a handshake procedure according to TCP being performed, and the DoIP connection may include transmitting a DoIP routing activation message between the plurality of communication nodes.

The method and apparatus for diagnostic communication in a vehicle according to an embodiment of the present disclosure may further include an operation in which one of a plurality of communication nodes (e.g., an edge communication node 14) receives a diagnostic message (diag) from outside of a vehicle 11 (e.g., a vehicle diagnostic apparatus 12), protocol converts or route the diagnostic message (diag), and transmits the diagnostic message (diag) to another of the plurality of communication nodes (e.g., a control communication node 15) after the operation (S10 in FIG. 6) in which one of the plurality of communication nodes is connected to another of the plurality of communication nodes for communication therewith (connection ended). Here, when at least one of the plurality of internal channels (CH-I1, CH-I2, CH-I3, CH-I4, and CH-I5) has a normal communication connection status, another of the plurality of communication nodes (e.g., a control communication node 15) may transmit a response message according to the diagnostic message (diag) to one of the plurality of communication nodes (e.g., an edge communication node 14), and one of the plurality of communication nodes (e.g., an edge communication node 14) may protocol convert or route the response message to the outside of the vehicle (e.g., the vehicle diagnostic apparatus 12). The outside of the vehicle (e.g., the vehicle diagnostic apparatus 12) may generate information of a diagnostic result of another of the plurality of communication nodes (e.g., a control communication node 15) based on the response message.

When at least one of the plurality of internal channels (CH-I1, CH-I2, CH-I3, CH-I4, and CH-I5) has an abnormal communication connection status, and one of the plurality of communication nodes (e.g., an edge communication node 14) does not recognize the abnormal communication connection status, one of the plurality of communication nodes (e.g., an edge communication node 14) may wait for a long time to receive a response message according to the diagnostic message (diag). That is, the impact of communication connection errors (e.g., communication failure/delay time, unnecessary resources in the vehicle network, confusion in diagnostic schedules) may be increased.

By the monitoring operation (S20 of FIG. 6), one of the plurality of communication nodes (e.g., edge communication node 14) may early recognize an abnormality in the communication connection status. That is, a time from a point in time when the abnormality in the communication connection status occurs to the time when one of the plurality of communication nodes (e.g., edge communication node 14) recognizes the abnormality in the communication connection status can be shortened. Therefore, the impact of communication connection errors (e.g., communication failure/delay time, unnecessary resources in the vehicular network, confusion in diagnostic schedules) may be effectively reduced.

For example, the predetermined communication connection error conditions (CQ1, CQ2, CQ3, and CQ4) may include a plurality of communication connection error conditions respectively corresponding to a plurality of layers of a communication model (e.g., OSI standard model, TCP/IP model), wherein the plurality of communication connection error conditions include an Ethernet link down condition (CQ1) corresponding to a physical layer or a network access layer of the communication model (e.g., OSI standard model, TCP/IP model); a TCP disconnection condition (CQ2) corresponding to a transmission layer of the communication model (e.g. OSI standard model, TCP/IP model); and a DoIP routing issue condition (CQ3) corresponding to an application layer of the communication model (e.g. OSI standard model, TCP/IP model).

For example, one of the plurality of communication nodes (e.g., edge communication node 14) may periodically monitor whether an Ethernet link is down (“Eth Link down”). If an Ethernet link is down, the edge communication node may generate information indicating that the communication connection status satisfies the Ethernet link down condition (CQ1). Additionally, the edge communication node (14) may determine whether an Ethernet link is down based on specialized methods for each type of “Eth Link down” (e.g., Ethernet cable disconnection, Ethernet cable connection instability, software link down).

For example, the TCP disconnection condition (CQ2) may correspond to receiving a TCP message (FIN/RST) with a connection termination flag (FIN flag) or a connection reset flag (RST flag) set from another of a plurality of communication nodes (e.g., a control communication node 15). That is, one of the plurality of communication nodes (e.g., edge communication node 14) may generate information that the communication connection status satisfies the TCP disconnection condition (CQ2) when receiving a TCP message (FIN/RST) with the connection termination flag (FIN flag) or connection reset flag (RST flag) set.

For example, when one of the plurality of communication nodes (e.g., an edge communication node 14) fails to route a message (e.g., a diagnostic message (diag)) received from the outside (e.g., a vehicle diagnostic apparatus 12) to another of the plurality of communication nodes (e.g., a control communication node 15) or routes the received message later than a reference time, it is possible to generate information that the communication connection status meets the DoIP routing issue condition (CQ3). For example, one of the plurality of communication nodes (e.g., edge communication node 14) may count a time from a point in time it receives a message (e.g., a diagnostic message (diag)) from the outside (e.g., a vehicle diagnostic apparatus 12) to a point in time it routes the message, and check whether the counted time exceeds the reference time.

For example, the monitoring operation (S20 of FIG. 6) may include periodically transmitting a monitoring message RM to another of the plurality of communication nodes (e.g., a control communication node 15). The plurality of communication connection error conditions may further include an active monitoring condition (CQ4) corresponding to not receiving a response within a first duration of transmitting a monitoring message R periodically to another of the plurality of communication nodes (e.g., a control communication node 15).

FIGS. 4A to 4C are diagrams illustrating a predetermined communication connection recovery procedure of a method and apparatus for diagnostic communication in a vehicle according to an embodiment of the present disclosure. Referring to FIG. 4A, the operation (S30 in FIG. 6) of performing predetermined communication recovery procedures (RQ1, RC1, RC2, and RC3) may include periodically (e.g., every 2 seconds) transmitting a recovery message (RQ1) to another of a plurality of communication nodes (e.g., a control communication node 15), being connected to another of the plurality of communication nodes (e.g., a control communication node 15) for communication therewith according to predetermined connection sequences (SQ1, SQ2, and SQ3) when a response (RQ2) according to the recovery message (RQ1) is received within a second duration (e.g., 20 times 2 seconds), and stopping the transmission of the recovery message (RQ1) when the response (RQ2) to the recovery message (RQ1) is not received within a second duration (e.g., 20 times 2 seconds).

For example, failing to receive a response (RQ2) to a recovery message (RQ1) within a second duration (e.g., 20 times 2 seconds) may be generated by a condition in which the time required for the communication connection to be restored is too long, or may be generated by an intentional disconnection of the communication connection. According to the interruption of the transmission of the recovery message (RQ1), unnecessary resources of the vehicle network may be reduced.

For example, the recovery message (RQ1) may include a vehicle identification request message of DoIP, and a response (RQ2) according to the recovery message (RQ1) may include a vehicle identification response message of DoIP. Since the vehicle identification request and vehicle identification response are messages defined by a diagnostic server search procedure of DoIP, the addition of customized messages to the recovery message (RQ1) and response (RQ2) may become unnecessary. Therefore, the recovery message (RQ1) and the response (RQ2) may be implemented reliably. For example, transmitting the recovery message (RQ1) and receiving the response (RQ2) may be implemented by performing the diagnostic server search procedure of DoIP. When the diagnostic server search procedure of DoIP has been performed in advance, transmitting the recovery message (RQ1) and receiving the response (RQ2) may be temporarily omitted.

For example, another of the plurality of communication nodes (e.g., the control communication node 15) may omit a vehicle announcement message when an Ethernet connection to one of the plurality of communication nodes (e.g., the edge communication node 14) changes from link down to link up. Since a general vehicle announcement message of DoIP may be transmitted to the outside of the vehicle (e.g., a vehicle diagnostic apparatus 12), it may cause unnecessary resources of the vehicle network. However, since transmitting a recovery message (RQ1) and receiving a response (RQ2) may replace at least a portion of the role of the vehicle announcement message, the vehicle announcement message may be omitted, and unnecessary resources of the vehicle network may also be reduced.

For example, the recovery message (RQ1) may include a User Datagram Protocol (UDP) message. Unlike TCP messages, UDP messages do not require a socket connection procedure (a pre-connection procedure between the plurality of communication nodes). Accordingly, transmission of the recovery message (RQ1), which is a UDP message, may not substantially add to vehicle network resources, and the vehicle network resources used in the operation (S30 of FIG. 6) of performing predetermined communication connection recovery procedures (RQ1, RC1, RC2, and RC3) may be reduced.

Referring to FIG. 4B, the operation (S30 in FIG. 6) of performing predetermined communication connection recovery procedures (RC2 and RC3) may omit the Ethernet connection recovery procedure (RC1 in FIG. 4A) in a predetermined connection sequence if the communication connection status satisfies a TCP disconnection condition (CQ2). Depending on the design, the Ethernet connection recovery procedure (RC1 in FIG. 4A) may also be omitted in a predetermined connection sequence if the communication connection status satisfies the routing issue condition of DoIP (CQ3) and/or the active monitoring condition (CQ4).

Referring to FIG. 4C, the operation (S30 of FIG. 6) of performing a predetermined communication connection recovery procedure (RC3) may omit the Ethernet connection recovery procedure (RC1 of FIG. 4A) and the TCP connection recovery procedure (RC2 of FIG. 4A) in a predetermined connection sequence if the communication connection status satisfies the routing issue condition of DoIP (CQ3). Depending on the design, the Ethernet connection recovery procedure (RC1 of FIG. 4A) and the TCP connection recovery procedure (RC2 of FIG. 4A) may be omitted in a predetermined connection sequence even if the communication connection status satisfies the active monitoring condition (CQ4 of FIG. 4A).

By the monitoring operation (S20 of FIG. 6), one of the plurality of communication nodes (e.g., edge communication node 14) may not only recognize a communication connection error, but also recognize the type of communication connection error (e.g., Ethernet link down, TCP disconnection, DoIP routing issue). Accordingly, one of the plurality of communication nodes (e.g., edge communication node 14) may perform communication connection recovery procedures (RC1, RC2, and RC3) customized for the type of communication connection error at the operation (S30 of FIG. 6) of performing a predetermined communication connection recovery procedure (RC3).

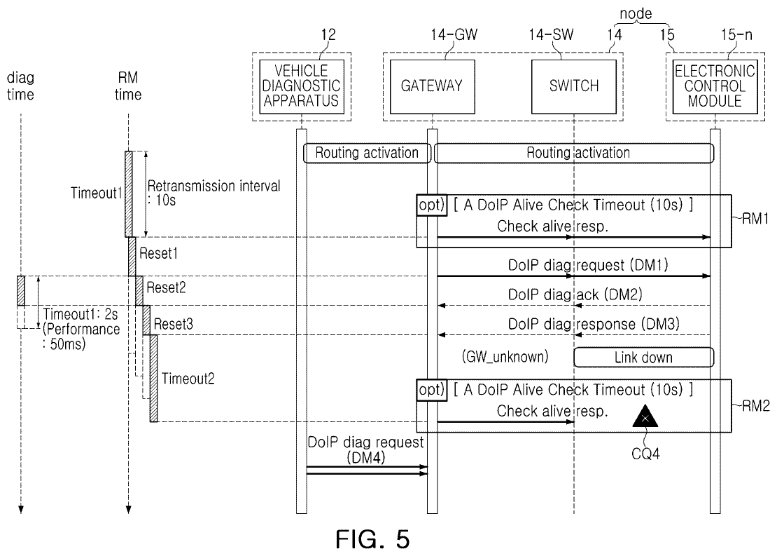

FIG. 5 is a diagram illustrating periodically transmitting a monitoring message by a method and apparatus for diagnostic communication in a vehicle according to an embodiment of the present disclosure. Referring to FIG. 5, the monitoring operation (S20 of FIG. 6) may include transmitting monitoring messages (RM, RM1, and RM2) at a time that does not overlap with a time of protocol conversion or routing of diagnostic messages (DM1 and DM4). For example, this could be implemented based on periodic expirations (Timeout1 and Timeout2) and resets (Reset1, Reset2, and Reset3).

For example, assuming that the monitoring messages RM, RM1, and RM2 are transmitted periodically every 10 seconds, the edge communication node 14 may reset (Reset 1) a 10-second period of the monitoring messages RM, RM1, and RM2, when transmitting a diagnostic message DM1 within 10 seconds from a time of transmitting the monitoring message RM1 due to periodic expiration (Timeout2), and reset (Reset 2, Reset 3) the 10-second period of the monitoring messages (RM, RM1, and RM2) when receiving response messages DM2 and DM4 according to the diagnostic message DM1. Each of the response messages DM2 and DM3 may be a response notifying that the diagnostic message DM1 has been received and a response notifying the diagnostic result, and may have a time difference of about 50 ms (2-second period expiration) between each other. For the next 10 seconds, the edge communication node 14 may not transmit a diagnostic message DM4, and may transmit a monitoring message RM2 due to periodic expiration (Timeout2).

Meanwhile, the edge communication node 14 may include an edge gateway 14-GW and a switch 14-SW, the edge gateway 14-GW may protocol convert or route a message received from a vehicle diagnostic apparatus 12, the switch 14-SW may be implemented as a protocol conversion switch or as a switch of selecting an electronic control module 15-n among a plurality of electronic control modules of the control communication node 15 to be connected to the edge gateway 14-GW.

When an Ethernet link is down only between the switch 14-SW and the control communication node 15, the edge gateway 14-GW may have difficulty in recognizing the Ethernet link down. The monitoring operation (S20 in FIG. 6) may include periodically transmitting monitoring messages (RM, RM1, and RM2) to a control communication node 15, so that the edge communication node 14 may monitor a communication connection error between the switch 14-SW and the control communication node 15 depending on whether or not a response from the control communication node 15 to the monitoring messages (RM, RM1, and RM2) is received.

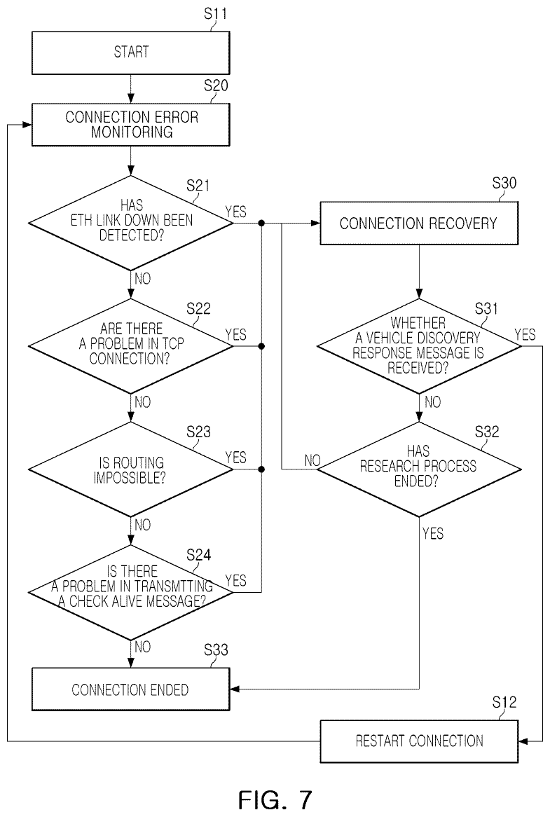

FIG. 7 is a flowchart illustrating a more specific example of a method and apparatus for diagnostic communication in a vehicle according to an embodiment of the present disclosure. The operation of FIG. 6 (S10) in which one of the plurality of communication nodes is connected to another of the plurality of communication nodes for communication therewith may include starting a communication connection of FIG. 7 (S11) and restarting the communication connection (S12). The monitoring operation (S20) of FIG. 6 may include checking (S21) detection of an Ethernet link down of FIG. 7, checking (S22) whether a problem has occurred in a TCP connection, checking (S23) whether routing is not performed, and checking (S24) whether there is a problem with transmission of a check alive message for active monitoring. The operation of performing a predetermined communication connection recovery procedure of FIG. 6 (S30) may include checking whether a vehicle discovery response message of FIG. 7 has been received (S31), checking whether a research process has ended (S32), and ending the connection when the research process has ended (S33).

For example, the vehicle discovery response may correspond to a response (RQ2) to the recovery message (RQ1) in FIG. 4A, and the edge control node (14) may restart the communication connection (S12) based on the response (RQ2). The research process may be conducted during a second duration (e.g., 40 seconds), which represents the time limit for receiving a response (RQ2) to the recovery message (RQ1) in FIG. 4A.

Meanwhile, referring to FIG. 1, a vehicle 11 according to an embodiment of the present disclosure may include a computing device 500 having a processor 501 and a storage medium 502 recording one or more programs 502a configured to be executable by the processor 501, and the one or more programs 502a may include commands for executing the method for diagnostic communication in a vehicle according to an embodiment of the present disclosure.

The computing device 500 may include at least one processor 501, a computer-readable storage medium 502, and a communication bus 503. The computing device 500 may interconnect various other components of the computing device 500, including the processor 501 and the computer-readable storage medium 502. For example, the computing device 500 may be implemented as a microcontroller.

The processor 501 may cause the computing device 500 to operate according to the above-described exemplary embodiments. For example, the processor 501 may execute one or more programs stored in the computer-readable storage medium 502. The one or more programs may include one or more computer executable instructions, wherein, when executed by the processor 501, the computer-readable executable instructions may be configured to cause the computing device 500 to perform operations according to an exemplary embodiment.

The computer-readable storage medium 502 may be configured to store computer-executable instructions or program code, program data, and/or other suitable forms of information. A program 502a stored on the computer-readable storage medium 502 includes a set of instructions executable by the processor 501. In an embodiment, the computer-readable storage medium 502 may include a memory (a volatile memory such as a random access memory, a non-volatile memory, or a suitable combination thereof), one or more magnetic disk storage devices, optical disk storage devices, flash memory devices, other forms of storage media that can be accessed by the computing device 500 and store desired information, or suitable combinations thereof.

The computing device 500 may also include one or more input/output interfaces 505 and one or more network communication interfaces 506 providing an interface for one or more input/output devices 504. The input/output interface 505 and the network communication interface 506 are connected to the communication bus 503. The network may be one of a cellular network, such as a global system for mobile communications (GSM), enhanced data rates for GSM evolution (EDGE), a general packet radio service (GPRS), a code division multiple access (CDMA), a time division CDMA (TD-CDMA), a universal mobile telecommunications system (UMTS), a long term evolution (LTE), or another cellular network.

The input/output device 504 may be connected to other components of the computing device 500 through the input/output interface 505. The exemplary input/output device 504 may include an input device such as a pointing device (a mouse, a trackpad, or the like), a keyboard, a touch input device (a touchpad, a touchscreen, or the like), a voice or sound input device, various types of sensor devices, and/or an imaging device, and an output device such as a display device, a printer, a speaker, and/or a network card. The exemplary input/output device 504 may be included inside the computing device 500 as a component constituting the computing device 500, or may be connected to the computing device 500 as a separate device, distinct from the computing device 500.

Meanwhile, embodiments of the present disclosure may include a program for performing the methods described in this specification on a computer, and a computer readable recording medium including the program. The computer-readable recording medium may include program instructions, local data files, local data structures, or the like, alone or in a combination thereof. The medium may be specially designed and configured for the present disclosure, or may be commonly available in the field of computer software. Examples of the computer-readable medium may include a hardware device specially configured to store a magnetic medium such as hard disks, floppy disks and magnetic tapes, an optical recording medium such as CD-ROMs and DVDs, and program instructions such as ROM, RAM, and a flash memory and perform the same. Examples of the program may include not only machine language codes generated by a compiler, but also high-level language codes that may be executed by a computer using an interpreter.

As set forth above, according to an embodiment of the present disclosure, in a method and apparatus for diagnostic communication in a vehicle and a vehicle including the same, by pre-defining a communication connection error recognition/recovery procedure between a plurality of communication nodes in the vehicle, before diagnosis, the impact of the occurrence of a communication connection error (e.g., communication failure/delay time, unnecessary resources of a vehicle network, confusion in diagnostic schedules) may be effectively reduced.

The present disclosure is not limited to the described embodiments and accompanying drawings but is defined by the appended claims. Accordingly, those skilled in the art may make various substitutions, modifications, or changes without departing from the scope of the present disclosure as defined by the appended claims, and such substitutions, modifications, or changes would be obvious to those skilled in the art.

What is claimed is:

1. A method for diagnostic communication in a vehicle, comprising:
an operation in which one of a plurality of communication nodes in a vehicle is connected to another of the plurality of communication nodes for communication therewith according to a predetermined connection sequence using a processor;
an operation in which one of the plurality of communication nodes monitors whether a communication connection status for another of the plurality of communication nodes satisfies a predetermined communication connection error condition using the processor; and
an operation in which one of the plurality of communication nodes selectively performs a predetermined communication connection recovery procedure depending on whether the communication connection status satisfies the predetermined communication connection error condition using the processor.

2. The method for diagnostic communication in the vehicle of claim 1, wherein the predetermined communication connection error condition includes a plurality of communication connection error conditions respectively corresponding to a plurality of layers of a communication model.

3. The method for diagnostic communication in the vehicle of claim 2, wherein the plurality of communication connection error conditions include:
an Ethernet link down condition corresponding to a physical layer or a network access layer of the communication model;
a Transmission Control Protocol (TCP) disconnection condition corresponding to a transmission layer of the communication model; and
a Diagnostic over Internet Protocol (DoIP) routing issue condition corresponding to an application layer of the communication model.

4. The method for diagnostic communication in the vehicle of claim 3, wherein the monitoring operation includes periodically transmitting a monitoring message to another of the plurality of communication nodes using the processor, and
the plurality of communication connection error conditions further include an active monitoring condition corresponding to not receiving a response according to periodically transmitting a monitoring message to another of the plurality of communication nodes within a first duration.

5. The method for diagnostic communication in the vehicle of claim 1, wherein the monitoring operation includes periodically transmitting a monitoring message to another of the plurality of communication nodes using the processor, and
the predetermined communication connection error condition includes an active monitoring condition corresponding to not receiving a response according to periodically transmitting a monitoring message to another of the plurality of communication nodes within a first duration.

6. The method for diagnostic communication in the vehicle of claim 5, further comprising:
an operation in which one of the plurality of communication nodes receives a diagnostic message from an outside of the vehicle and protocol converts or route the diagnostic message and transmits the diagnostic message to another of the plurality of communication nodes using the processor,
wherein the monitoring operation includes transmitting the monitoring message at a time that does not overlap with a time of protocol conversion or routing of the diagnostic message.

7. The method for diagnostic communication in the vehicle of claim 1, wherein the predetermined communication connection error condition includes a TCP disconnection condition receiving a transmission control protocol (TCP) message with a connection finish flag (FIN flag) or a connection reset flag (RST flag) set from another of the plurality of communication nodes using the processor.

8. The method for diagnostic communication in the vehicle of claim 7, wherein the predetermined connection sequence includes an Ethernet connection, a TCP connection, and a Diagnostic over internet protocol (DoIP) connection.

9. The method for diagnostic communication in the vehicle of claim 1, wherein the operation of performing the predetermined communication connection recovery procedure includes using the processor to:
periodically transmit a recovery message to another of the plurality of communication nodes,
connect to another of the plurality of communication nodes for communication therewith when a response according to the recovery message is received within a second duration, and
stop the transmission of the recovery message when the response according to the recovery message is not received within the second duration.

10. The method for diagnostic communication in the vehicle of claim 9, wherein the predetermined connection sequence includes an Ethernet connection and a Diagnostic over Internet Protocol (DoIP) connection,
the recovery message includes a vehicle identification request message of DoIP, and
the response according to the recovery message includes a vehicle identification response message of the DoIP.

11. The method for diagnostic communication in the vehicle of claim 9, wherein the predetermined connection sequence includes an Ethernet connection and a Diagnostic over Internet Protocol (DoIP) connection, and
another of the plurality of communication nodes omits a vehicle announcement message when an Ethernet connection to one of the plurality of communication nodes changes from link down condition to link up condition using the processor.

12. The method for diagnostic communication in the vehicle of claim 9, wherein the predetermined connection sequence includes a Transmission Control Protocol (TCP) connection, and
the recovery message includes a User Datagram Protocol (UDP) message.

13. The method for diagnostic communication in the vehicle of claim 9, wherein the predetermined connection sequence includes an Ethernet connection, a TCP connection, and a Diagnostic over Internet Protocol (DoIP) connection,
wherein the communication connection error condition includes a plurality of communication connection error conditions including:
an Ethernet link down condition corresponding to a physical layer or a network access layer of a communication model;
a Transmission Control Protocol (TCP) disconnection condition corresponding to a transmission layer of the communication model; and
a Diagnostic over Internet Protocol (DoIP) routing issue condition corresponding to an application layer of the communication model,
wherein the operation of performing the predetermined communication connection recovery procedure includes using the processor to:
omit the Ethernet connection recovery procedure in the predetermined connection sequence when the communication connection status satisfies the TCP disconnection condition, and omit the Ethernet connection recovery procedure and the TCP connection recovery procedure in the predetermined connection sequence when the communication connection status satisfies a DoIP routing issue condition.

14. An apparatus for diagnostic communication in a vehicle, comprising:
an edge communication node configured to receive a message from outside of a vehicle and protocol convert or route the received message using a processor; and
a control communication node configured to receive the message protocol converted or routed by the edge communication node using the processor,
wherein the edge communication node is configured to be connected to the control communication node for communication therewith according to a predetermined connection sequence, and monitor whether a communication connection status for the control communication node satisfies a predetermined communication connection error condition, and selectively perform a predetermined communication connection recovery procedure depending on whether the communication connection status satisfies the predetermined communication connection error condition using the processor.

15. The apparatus for diagnostic communication in the vehicle of claim 14, wherein the edge communication node periodically transmits a monitoring message to the control communication node using the processor, and
the predetermined communication connection error condition includes an active monitoring condition corresponding to not receiving a response according to periodically transmitting a monitoring message to the control communication node within a first duration using the processor.

16. The apparatus for diagnostic communication in the vehicle of claim 15, wherein the predetermined communication connection error condition further includes:
an Ethernet link down condition corresponding to a physical layer or a network access layer of a communication model;
a Transmission Control Protocol (TCP) disconnection condition corresponding to a transmission layer of the communication model; and
a Diagnostic over Internet Protocol (DoIP) routing issue condition corresponding to an application layer of the communication model,
wherein the predetermined connection sequence includes an Ethernet connection, a TCP connection, and a Diagnostic over Internet Protocol (DoIP) connection.

17. The apparatus for diagnostic communication in the vehicle of claim 14, wherein the edge communication node periodically transmits a recovery message to the control communication node, is connected to the control communication node for communication therewith according to the predetermined connection sequence when a response according to the recovery message is received within a second duration, and stops the transmission of the recovery message when the response according to the recovery message is not received within the second duration using the processor.

18. The apparatus for diagnostic communication in the vehicle of claim 17, wherein the predetermined connection sequence includes an Ethernet connection, a Transmission Control Protocol (TCP) connection, and a Diagnostic over Internet Protocol (DoIP) connection, and
the recovery message includes a User Datagram Protocol (UDP) message.

19. The apparatus for diagnostic communication in the vehicle of claim 14, wherein the control communication node includes a control gateway and an electronic control module,
wherein the control gateway is configured to be connected to the electronic control module for communication therewith according to a predetermined connection sequence, monitor whether a communication connection status for the electronic control module satisfies the predetermined communication connection error condition, and selectively perform the predetermined communication connection recovery procedure depending on whether the communication connection status satisfies the predetermined communication connection error condition using the processor.

20. A vehicle, comprising:
a computing device having the processor and a storage medium on which one or more programs configured to be executed by the processor is recorded,
wherein the one or more programs include commands for executing the method for diagnostic communication in the vehicle of claim 1.
